(19) United States
(12) Patent Application Publication
(10) Pub. No.: US 2003/0059270 A1
(43) Pub. Date: Mar. 27, 2003

(54) Double pitch screw

(76) Inventor: Patrick Brian O'Berry, Lindenhurst, IL (US)

Correspondence Address: Mathew R. P. Perrone, Jr., Patent Attorney, 210 South Main Street, Algonquin, IL, 60102, US

(21) Appl. No.: 10/190,664

(22) Filed: Jul. 8, 2002

Related U.S. Application Data
(62) Division of application No. 09/960,193, filed on Sep. 21, 2001.

(51) Int. Cl. F16B 31/00

(52) U.S. Cl. 411/2

(57) ABSTRACT

A double pitch screw having a head at one and a drive point at the other end thereof, with a clear unthreaded shank between a set of low pitch threads adjacent to the drive point and a set of high pitch threads adjacent to the head and the break point.

### BACKGROUND OF THE INVENTION

For a home, a useful exterior attachment or addition is a wooden deck. Such a deck can provide a convenient place to have an outdoor party or a number of other functions. For example, a swimming pool may well have a wooden deck therearound. Also, the wooden deck may provide access to a hot tub. Thus, a wooden deck can be useful.

Additionally, the wooden deck may have a commercial application also. For example, a restaurant may have a wooden deck in order to assist the ambience of outside seating. Additionally, a deck like structure may even be used inside. Clearly, a wooden deck is useful.

Typically, the support for the wooden deck must have the actual walking surface securely attached thereto. If this can be accomplished, the wooden deck can have a more solid, desirable feel. Additionally, if that secure attachment is achieved, annoying squeaks can be avoided as one walks on the deck.

Squeaky floors on a deck or in the house can be an annoyance, or even a safety hazard. The squeak occurs due to an imperfect relation between a solid flooring material and the joists supporting the flooring material. Such squeaky floors are clearly discussed in U.S. Pat. No. 5,372,466 to Jon L. O'Berry.

Also, a tight fit between the joist and floor surface minimizes flexibility of the surface. With such minimized flexibility, wear and tear on the floor surface is reduced and the surface can last longer. However, known fasteners do not minimize that flexibility and do not hold tightly because of the flexibility.

Additionally, the fastener can make it difficult to refinish the deck. The aperture caused by the fastener is difficult to finish. Also, the fastener itself can interfere with the refinishing process itself. Yet such processes are necessary to maintain a deck. Not only does the finish provide decoration, it also provides protection from the elements. With this protection, a deck may last longer.

### SUMMARY OF THE INVENTION

Among the many objectives of this invention is the provision of a double pitch screw adapted to fasten two boards tightly together.

A further objective of this invention is to provide a double pitch screw, which minimizes surface flexibility.

A still further objective of this invention is to provide a double pitch screw to join a surface to a joist.

Yet a further objective of this invention is to provide a double pitch screw to minimize wear on a surface.

Also, an objective of this invention is to provide a method of joining a surface to a joist.

Another objective of this invention is to provide a fastener, which minimizes interference with refinishing of a surface.

Yet another objective of this invention is to provide a fastener to join a surface to a joist.

Still, another objective of this invention is to provide an improved method of refinishing a surface.

These and other objectives of the invention (which other objectives become clear by consideration of the specification, claims and drawings as a whole) are met by providing a double pitch screw having a head at one end and a drive point at the other end thereof, with a clear unthreaded shank between a set of lower numbered pitch threads and a set of higher numbered pitch threads.

### BRIEF DESCRIPTION OF THE DRAWINGS

FIG. 1 depicts a side view of the double pitch screw 100, of this invention.

FIG. 2 depicts a top plan view of the double pitch screw 100, of this invention.

FIG. 3 depicts a side view of a top portion 120 of the double pitch screw 100, of this invention, in use.

FIG. 4 depicts a side view of a bottom portion 140 of the double pitch screw 100, of this invention, as finished.

Throughout the figures of the drawings, where the same part appears in more than one figure of the drawings, the same number is applied thereto.

### DESCRIPTION OF THE PREFERRED EMBODIMENTS

The double pitch screw includes a threaded screw with two sets of threads. On the double pitch screw is a screw head at one end and a drive point at the other end thereof. Adjacent to the screw head is a score on the barrel of the screw. That score permits the screw head to be separated from the barrel of the screw.

The pitch for a screw refers to number of threads per inch of the screw. The preferred screw of this invention has a pitch of a higher number, that is a greater number of threads per inch, closest to the head of the screw. Adjacent to the score and oppositely disposed from the screw head is the set of higher numbered pitch threads, that is to say finer threads. Adjacent to the drive point is the set of lower numbered pitch threads, that is to say more coarse set of threads.

Preferably, a break score is adjacent to the head of the screw. More particularly, the break score is between the head of the screw and the pitch of the screw at the higher number. In this fashion, the head of the screw can be removed after the break score is slightly below the surface. By this structure, the screw may be hidden, while providing the tight bond between the joist and the surface.

Also preferably, between the set of lower numbered pitch threads and the set of higher numbered pitch threads is a clear unthreaded shank on the barrel of the screw. The unthreaded shank provides for the tight drawing together of joist and the surface.

While is not desired to be bound by any particular theory, the following postulate is offered. The lower pitch threads adjacent to the drive point go through the wood faster. The higher pitch threads adjacent to the screw head thus pull the surface board tightly to the joist. When the screw head is severed from the threads, the separation of the wood caused by the screw returns to position and conceals the aperture made by the screw, thereby permitting a better appearance and more efficient refinishing of the surface. Such concealing of the screw, after it is driven into the wood and has the head separated therefrom, is believed to be caused by the expansion of the wood.

In a preferred form, threads adjacent to the head have a pitch of nine, while threads adjacent to the drive point have a pitch of eight. For most wooden decks, this pitch arrangement is extremely effective. The head may have any appropriate drive mechanism. A Frearson drive, a clutch drive, a hex drive, a socket drive, a Pozi drive, a recess drive, a universal drive, a square drive, a Phillips drive, a slot drive, a torx drive or other suitable drive are all appropriate drives.

The head may be separated from the screw in any suitable fashion. A hammer may be used. Various fixtures are also known to cooperate with the scored screw and provide an efficient device for separating the head from the barrel of the screw. Such fixtures are clearly discussed in U.S. Pat. No. 5,372,466 to Jon L. O'Berry and U.S. Pat. No. 6,250,186 to Patrick Brian O'Berry, the inventor of this application, both patents being incorporated herein by reference.

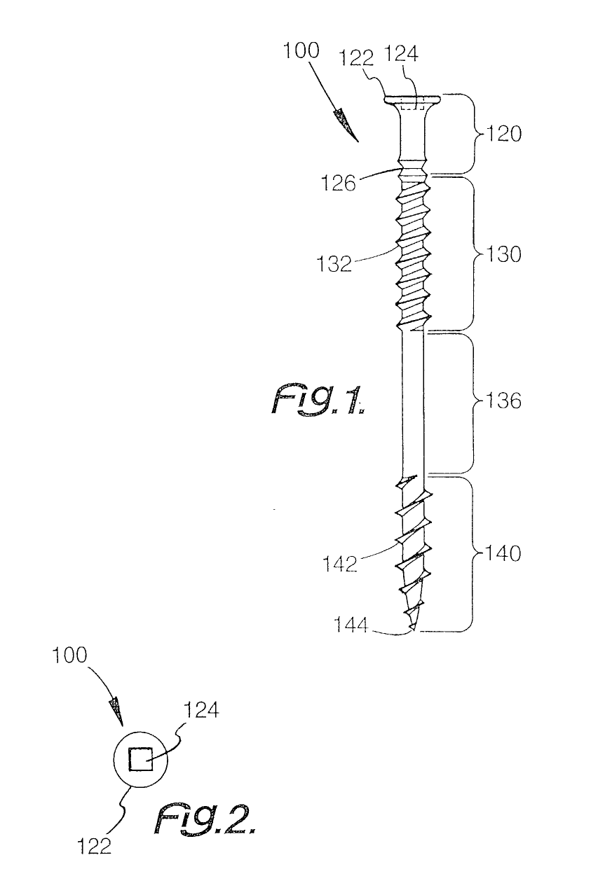

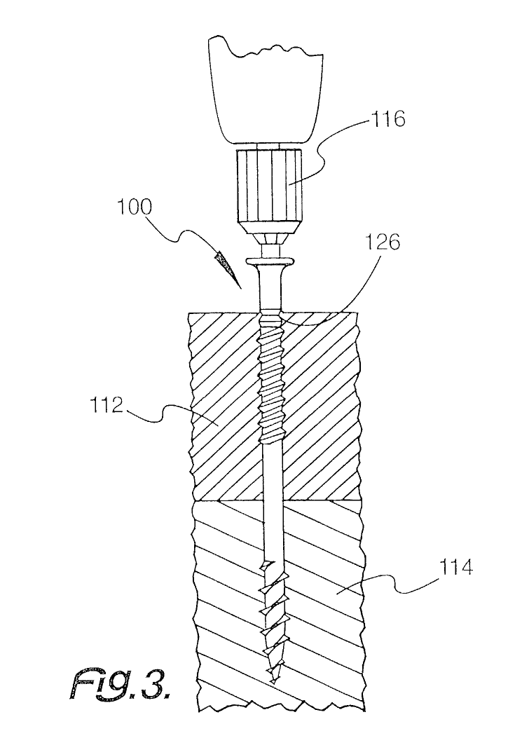

Referring now to FIG. 1, FIG. 2 and FIG. 3 collectively, the double pitch screw 100, at the top portion 120, has a screw head 122. Drill 116 has the appropriate to drive the double pitch screw 100.

As shown, screw head 122 includes a square drive socket 124. As is clear, any appropriate driving shape may he used in the screw head 122. Adjacent to the screw head 122 is a break score 126. Head 122 may be severed from the rest of screw 100 at that point.

From the top portion 120, adjacent to break score 126 and oppositely disposed from the screw head 122, is the upper threaded shank 130. Upper threaded shank 130 has first pitch threads 132 thereon. Adjacent to upper threaded shank 130 and oppositely disposed from the break score 126 is the clear shank 136, which has no threads thereon.

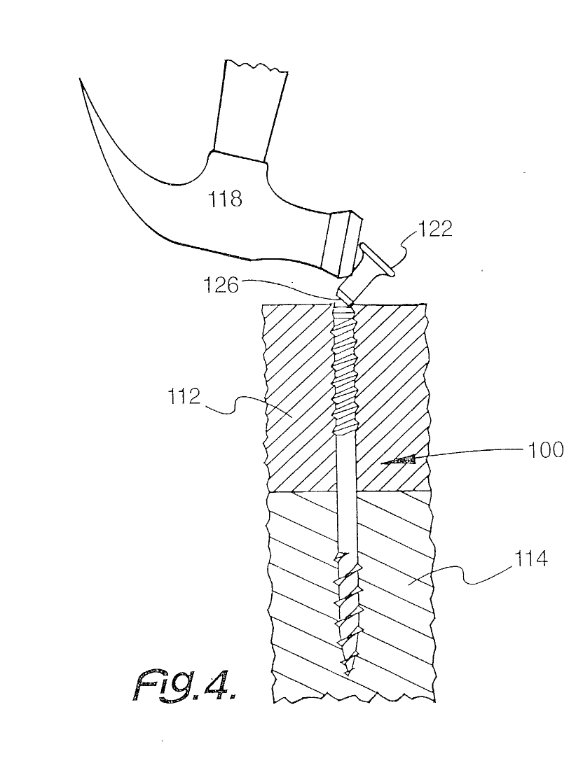

Adding FIG. 4 to the consideration, lower portion 140 of double pitch screw 100 has second pitch threads 142 thereon. Second pitch threads 142 terminate in drive point 144. Drive point 144 assists double pitch screw 100 in driving through surface board 112 and into joist board 114.

With first pitch threads 132 having a higher pitch number than second pitch threads 144, and clear shank being partially in both surface board 112 and joist board 114, surface board 112 and joist board 114 may be so tightly drawn together, so the break score 136 separates the screw head 122, from the rest of double pitch screw 100. Alternatively, hammer 118 or other tool may assist the breaking.

This application—taken as a whole with the abstract, specification, claims, and drawings being combined—provides sufficient information for a person having ordinary skill in the art to practice the invention as disclosed and claimed herein. Any measures necessary to practice this invention are well within the skill of a person having ordinary skill in this art after that person has made a careful study of this disclosure.

Because of this disclosure and solely because of this disclosure, modification of this method and apparatus can become clear to a person having ordinary skill in this particular art. Such modifications are clearly covered by this disclosure.

What is claimed and sought to be protected by Letters Patent of the United States is:

1. A double pitch screw with a head and a barrel adapted to join two pieces of material tightly together, comprising:
(a) the double pitch screw having a head at a first end of the barrel and a drive point at a second end of the barrel;
(b) the first end being oppositely disposed from the second end;
(c) the double pitch screw having a first set of threads and a second set of threads on the barrel;
(d) the first set of threads being adjacent to the head;
(e) the second set of threads being adjacent to the drive point; and
(f) the first set of threads having a high pitch number relative to the second set of threads.

2. The double pitch screw of claim 1, further comprising:
(a) a break score being on the barrel between the first set of threads and the head; and
(b) the break score being adapted to assist the separation of the barrel and the head; and
(c) a clear shank being on the barrel between the first set of threads and the second set of threads.

3. The double pitch screw of claim 2, further comprising the head having a drive mechanism selected from the group consisting of A Frearson drive, a clutch drive, a hex drive, a socket drive, a Pozi drive, a recess drive, a universal drive, a square drive, a Phillips drive, a slot drive, a torx drive or other suitable drive.

4. The double pitch screw of claim 3, further comprising the head having a square drive mechanism.

5. In a deck having at least one surface board joined to at least one joist by a fastener, the improvement comprising:
(a) the fastener being a double pitch screw;
(b) the double pitch screw having a head and a barrel adapted to join two pieces of material tightly together;
(c) the double pitch screw having a head at a first end of the barrel and a drive point at a second end of the barrel;
(d) the first end being oppositely disposed from the second end;
(e) the double pitch screw having a first set of threads and a second set of threads on the barrel;
(f) the first set of threads being adjacent to the head;
(g) the second set of threads being adjacent to the drive point; and
(h) the first set of threads having a high pitch number relative to the second set of threads.

6. The deck of claim 5, further comprising:
(a) a break score being on the barrel between the first set of threads and the head; and
(b) a clear shank being on the barrel between the first set of threads and the second set of threads.

7. The deck of claim 6, further comprising the head having a drive mechanism selected from the group consisting of A Frearson drive, a clutch drive, a hex drive, a socket drive, a Pozi drive, a recess drive, a universal drive, a square drive, a Phillips drive, a slot drive, a torx drive or other suitable drive.

8. The deck of claim 7 the head having a square drive mechanism.

9. A method for forming a deck having at least one surface board joined to at least one joist by a fastener, comprising:
(a) placing a surface board adjacent to a joist;
(b) driving a double pitch screw through the surface board into the joist;
the double pitch screw having a head and a barrel adapted to join two pieces of material tightly together;
the double pitch screw having a head at a first end of the barrel and a drive point at a second end of the barrel;
the first end being oppositely disposed from the second end;
the double pitch screw having a first set of threads and a second set of threads on the barrel;
the first set of threads being adjacent to the head;
the second set of threads being adjacent to the drive point; and
the first set of threads having a high pitch number relative to the second set of threads;
(c) severing the head from the screw.

10. The method of claim 9, further comprising:
(a) a break score being on the barrel between the first set of threads and the head; and
(b) a clear shank being on the barrel between the first set of threads and the second set of threads.

11. The method of claim 10, further comprising:
(a) forming an aperture in the surface board with the drive point; and
(b) allowing the aperture to close.

12. The method of claim 11, further comprising the head having a drive mechanism selected from the group consisting of A Frearson drive, a clutch drive, a hex drive, a socket drive, a Pozi drive, a recess drive, a universal drive, a square drive, a Phillips drive, a slot drive, a torx drive or other suitable drive.

13. The method of claim 12, further comprising the head having a square drive mechanism.
